(19) United States
(12) Patent Application Publication
(10) Pub. No.: US 2024/0383138 A1
(43) Pub. Date: Nov. 21, 2024

(54) ROBOT CONTROL SYSTEM, ROBOT CONTROL METHOD, AND ROBOT CONTROL DEVICE

(71) Applicant: Hitachi, Ltd., Tokyo (JP)

(72) Inventors: Kanta HAMASAKI, Tokyo (JP); Hiroshi ITO, Tokyo (JP); Andre Yuji YASUTOMI, Tokyo (JP); Juri SHIMIZU, Tokyo (JP)

(73) Assignee: Hitachi, Ltd., Tokyo (JP)

(21) Appl. No.: 18/665,280

(22) Filed: May 15, 2024

(30) Foreign Application Priority Data
May 16, 2023 (JP) 2023-080693

(51) Int. Cl. B25J 9/16; B25J 5/00; B62D 57/032

(52) U.S. Cl. CPC B25J 9/1664; B25J 5/00; B62D 57/032

(57) ABSTRACT

[Problem]To provide a robot control system that can easily obtain an appropriate moving part control law even when there are many combinations of arm states and moving part states to achieve a target motion.

[Solution]A robot control system includes: a robot including an arm and a moving part; and a control device that controls the robot. The control device includes; a motion planning part that outputs a target motion associated with a motion of the arm and an allowable range for the motion of the moving part corresponding to the target motion; an arm control part that outputs an arm control instruction associated with the target motion and an arm state transition; and a movement control part that generates a movement control instruction associated with a motion of the moving part to fall within the allowable range using the arm state transition. The robot has the arm controlled by the arm control instruction and has the moving part controlled by the movement control instruction.

### CLAIM OF PRIORITY

The present application claims priority from Japanese Patent application serial no. 2023-080693, filed on May 16, 2023, the content of which is hereby incorporated by reference into this application.

### TECHNICAL FIELD

The present invention relates to a robot control system, a robot control method, and a robot control device.

### BACKGROUND ART

Recently, labor shortage due to declining birthrate and aging population, dangerous work in a disaster area, and the like have been arising as social problems. For the purpose of solving these problems, it is expected to utilize a robot in various works even in an environment other than in a factory or the like maintained so that the robot can safely and efficiently work (hereinbelow, referred to as “unstructured environment”).

In order for a robot having an arm and a moving part to autonomously carry out its work under the unstructured environment such as the disaster area, in addition to arm control for skillfully maneuvering an operation object, movement control for properly moving close to the operation object is required. Examples of robots having achieved such control functions are, for example, a two-wheel drive carriage, a crawler-type robot, a four-legged robot, a humanoid robot (humanoid), an unmanned aerial vehicle (UAV), and the like equipped with a manipulator.

As an example of this kind of robot, a mobile manipulator disclosed in Nonpatent Literature 1 has been known. Nonpatent Literature 1 proposes a robot control method of preparing an arm controller (arm controller) and a movement controller (base controller) for a mobile manipulator (Legged Mobile Manipulator) separately and obtaining a control law (control instruction) for the moving part based on a behavior of an arm using deep reinforcement learning (Deep reinforcement learning).

### CITATION LIST

### Nonpatent Literature

Nonpatent Literature 1: Y. Ma, F. Farshidian, T. Miki, J. Lee and M. Hutter, “Combining Learning-based Locomotion Policy with Model-based Manipulation for Legged Mobile Manipulators,” arXiv:2201.03871v1, 2022.

### SUMMARY OF INVENTION

### Technical Problem

There are various target motions to be performed by a robot in an unstructured environment including, for example, a motion of changing a position or a posture of the operation object such as gripping, carrying, installing the operation object, opening/closing a door, a lever operation, and the like, and a motion of processing the operation object such as welding, painting, cutting, assembling, and the like.

According to Nonpatent Literature 1, since the arm controller and the movement controller are independent from one another, it is possible to have the arm perform a new target motion only by changing the control law for the arm controller. It is also possible to implement a new target motion rather easily since already established arm motion generation technology can be utilized to change the control law for the arm.

However, the control method for the moving part according to Nonpatent Literature 1 has a problem that the moving part can be stably controlled only under the conditions taken into consideration when learning the control law for the moving part. Accordingly, when there are many combinations of an arm state and a moving part state for performing the target motion, it is difficult to obtain an appropriate control law for the moving part. For example, when performing a control by changing the posture of the moving part to increase a reachable range of the arm, it is difficult to obtain the appropriate control law for the moving part because too many combinations of the states must be taken into consideration if an effect of inertia force of the moving arm.

Therefore, an object of the present invention is to provide a robot control system, a robot control method, and a robot control device allowing for easily obtaining an appropriate moving part control law even when there are many combinations of arm states and moving part states to achieve the target motion.

### Solution to Problem

To solve the above-described problems, a robot control system according to an embodiment of the present invention includes: a robot including an arm; and a moving part and a control device that controls the robot, in which the control device includes a motion planning part that outputs a target motion associated with a motion of the arm and an allowable range for the motion of the moving part corresponding to the target motion, an arm control part that outputs an arm control instruction associated with the target motion and an arm state transition, and a movement control part that generates a movement control instruction associated with the motion of the moving part to fall within the allowable range using the arm state transition, and in which the robot has the arm controlled by the arm control instruction and has the moving part controlled by the movement control instruction.

### Advantageous Effects of Invention

According to the robot control system, the robot control method, and the robot control device of the present invention, it is possible to easily obtain an appropriate moving part control law even when there are many combinations of the arm states and the moving part states to achieve the target motion.

### BRIEF DESCRIPTION OF DRAWINGS

FIG. 1 illustrates a configuration of a robot control system according to First Embodiment;

FIG. 2A illustrates a four-legged robot as an example of the robot;

FIG. 2B illustrates a humanoid robot as an example of the robot;

FIG. 2C illustrates an unmanned aerial vehicle as an example of the robot;

FIG. 3 illustrates a target motion of an arm according to First Embodiment;

FIG. 4 illustrates a state of the robot and its peripheral environment when a control according to First Embodiment is performed;

FIG. 5 illustrates a time change in position of an end effector in the arm when the control according to First Embodiment is performed;

FIG. 6 illustrates a time change in amount of electric power output to a motor that drives an articulation of a leg when the control according to First Embodiment is performed;

FIG. 7 illustrates a target motion of an arm according to Second Embodiment;

FIG. 8 illustrates a configuration of a robot control system according to Second Embodiment;

FIG. 9 illustrates a state of the robot and the peripheral environment when a control according to Second Embodiment is performed;

FIG. 10 illustrates a time change in moving speed of a base when the control according to Second Embodiment is performed;

FIG. 11 illustrates a time change in amount of electric power output to a motor that drives an articulation of a leg when the control according to Second Embodiment is performed;

FIG. 12 illustrates a configuration of a robot control system according to Third Embodiment;

FIG. 13 illustrates an example display on a display part according to Third Embodiment; and

FIG. 14 illustrates a configuration of a robot control system according to Fourth Embodiment.

### DESCRIPTION OF EMBODIMENTS

In the following, example embodiments of the present invention will be described with reference to accompanying drawings. The present invention is not limited to the following embodiments, and various values and the like in the embodiments are merely embodiments. In the present description and drawings, the same components or components having the same function shall be denoted with the same symbol, and description thereof shall be omitted.

### First Embodiment

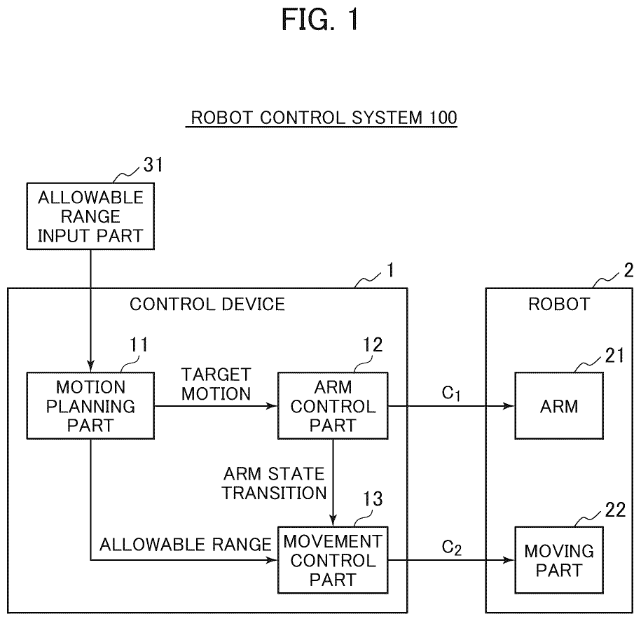

FIG. 1 illustrates a configuration of a robot control system 100 according to First Embodiment of the present invention. The robot control system 100 is a system having a control device 1, a robot 2, and an allowable range input part 31. The control device 1 is constituted by a motion planning part 11, an arm control part 12, and a movement control part 13. The control device 1 is specifically a computer including hardware, e.g., an arithmetic unit such as a CPU, a main storage unit such as a semiconductor memory, an auxiliary storage unit such as a hard disk, a communication unit, and the like. Although each function unit such as the motion planning part 11 is implemented by the arithmetic unit executing a predetermined program, such known technologies are omitted in the following description as appropriate. Moreover, the robot 2 is constituted by a manipulator (arm 21) that operates an operation object and a moving part 22 used when moving. The allowable range input part 31 is a human-machine interface that a user uses to input information required for robot control to the control device 1.

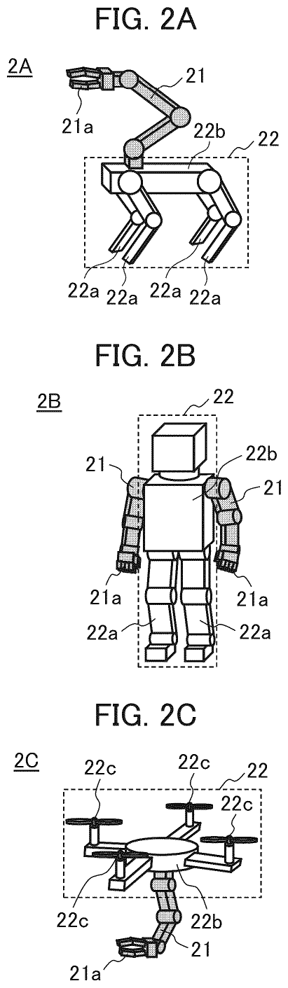

FIG. 2A illustrates a configuration of a four-legged robot 2A as an example of the robot 2. The four-legged robot 2A includes one 6-articulation arm 21 having an end effector 21a at its tip. Moreover, the moving part 22 of the four-legged robot 2A is provided with four 3-articulation legs 22a and a base 22b having the arm 21 and the legs 22a attached thereto.

FIG. 2B illustrates a configuration of a humanoid robot 2B as an example of the robot 2. The humanoid robot 2B includes the 6-articulation arm 21 having the end effector 21a at its tip on each of the right side and the left side. Moreover, the moving part 22 of the humanoid robot 2B is provided with two 6-articulation legs 22a and the base 22b having the arms 21 and the legs 22a attached thereto.

FIG. 2C illustrates a configuration of an unmanned aerial vehicle 2C as an example of the robot 2. The unmanned aerial vehicle 2C includes one 6-articulation arm 21 having an end effector 21a at its tip. Moreover, the moving part 22 of the unmanned aerial vehicle 2C is provided with four rotor blades 22c that generate aerodynamic lift and thrust and the base 22b having the arm 21 and the rotor blades 22c attached thereto.

The four-legged robot 2A and the humanoid robot 2B include a driving mechanism for driving the arms 21 and the legs 22a at each articulation. The unmanned aerial vehicle 2C includes a driving mechanism for driving the arm 21 at each articulation, and includes a driving mechanism for controlling a posture of the moving part 22 at each rotor blade 22c. At this point, there may be fewer driving part in the arm 21 or the leg 22a than the articulations so that a single driving part controls a plurality of articulations. Moreover, the numbers of the articulations provided in the arm 21 and the leg 22a or the numbers of the arms 21, the legs 22a, and the rotor blades 22c are not limited to the examples shown in FIGS. 2A to 2C but may be increased or decreased. In addition, there may be provided other portions (e.g., tail). Moreover, the mechanism included in the moving part 22 for achieving the movement is not limited to the leg 22a and the rotor blade 22c but may be a wheel or a crawler. In addition, the robot control system 100 shown in FIG. 1 can consider both cases where the robot 2 is present in an actual environment and in a virtual environment.

### <Method of Controlling Arm 21>

Now, a method of controlling the arm 21 of the robot 2 is described. First, the motion planning part 11 of the control device 1 instructs to the arm control part 12 a target motion to be performed by the arm 21. The target motion corresponds to every motion that can be performed by the arm 21. For example, the target motion can be movement (gripping, transport, installation, operation, and the like), processing (coating, cutting, welding, assembling, wiping, and the like), observation (instrument reading, surface inspection, appearance inspection, and the like) of the operation object.

Based on the target motion instructed by the motion planning part 11, the arm control part 12 generates a motion sequence to achieve the target motion. Any technique can be applied to generating the motion sequence. For example, a rule-based control technique based on a program generated in advance, or a learning-type control technique based on a learned control law may be applied.

The motion sequence generated by the arm control part 12 is input to the arm 21 at an arbitrary control cycle Tₐ as an arm control instruction C₁, and the arm 21 moves on the basis on the arm control instruction C₁. The arm control instruction C₁ is an instruction to rotate or translate each articulation of the arm 21, e.g., specifies a temporal change in an angle, an angular speed, an angular acceleration (torque) of each articulation. In a case in which the arm control part 12 generates a motion based on a difference between the arm control instruction C₁ and an actual state of the arm 21 or a state of the peripheral environment, the arm control part 12 can use information from various sensors included in the robot 2.

### <Method of Controlling Moving Part 22>

Now, a method of controlling the moving part 22 of the robot 2 is described. In a case of the robot 2 including the arm 21 and the moving part 22, the movement control part 13 of the control device 1 controls the moving part 22 to follow a target state (e.g., a position or a posture of the base 22b) instructed from the motion planning part 11 to achieve the target motion of the arm 21. At this point, the movement control part 13 needs to control the moving part 22 taking into consideration the effect of the inertia force by moving the arm 21.

In order to control the moving part 22 to follow the target state, it suffices to derive a control input so that a difference between the actual state and the target state of the moving part 22 is small. By setting a problem to minimize the control input as much as possible, the following optimal control problem is obtained for a predetermined evaluation period [t₀,t_{f}].

$$\begin{matrix}[ Math . 1 ] & \\ {min}_{u ( \cdot )} φ ( x ( {t}_{f} ) ) + {\int }_{{t}_{0}}^{{t}_{f}} L ( x ( t ) , u ( t ) , t ) dt & Formula 1\end{matrix}$$

$$\begin{matrix}[ Math . 2 ] & \\ L ( x ( t ) , u ( t ) , t ) = {( x - {x}_{ref} )}^{T} Q ( x - {x}_{ref} ) + {u}^{T} Ru & Formula 2\end{matrix}$$

$$\begin{matrix}[ Math . 3 ] & \\ φ ( x ( {t}_{f} ) ) = {( x - {x}_{ref} )}^{T} P ( x - {x}_{ref} ) & Formula 3\end{matrix}$$

wherein φ and L are evaluation functions, x is a state vector, u is an input vector, x_{ref} is a target state vector, and P, Q, R are weight matrices. Including a variant pertaining to the state of the moving part 22 in X and x_{ref} results in achievement of control to follow the target state. Moreover, a term defined in the evaluation function L is not limited to Formula 2. For example, there can be added a term that evaluates an amount of power consumption, a term that evaluates safety for avoiding a collision of the robot 2 with itself or its peripheral environment, and the like. It should be noted that a target track of a state vector x can be defined by a trajectory of time series change of the target state vector x_{ref}.

To solve the optimal control problem of Formulae 1 to 3, it is required to estimate a time evolution of the state vector x. Thus, the following constraint conditions can be defined for the optimal control problem of Formulae 1 to 3.

$$\begin{matrix}[ Math . 4 ] & \\ \dot{x} ( t ) = f ( x ( t ) , u ( t ) , t ) & Formula 4\end{matrix}$$

$$\begin{matrix}[ Math . 5 ] & \\ x ( {t}_{0} ) = {x}_{0} & Formula 5\end{matrix}$$

$$\begin{matrix}[ Math . 6 ] & \\ g ( x ( t ) , u ( t ) , t ) = 0 & Formula 6\end{matrix}$$

$$\begin{matrix}[ Math . 7 ] & \\ h ( x ( t ) , u ( t ) , t ) \geq 0 & Formula 7\end{matrix}$$

wherein Formula 4 represents a kinetic model of the robot 2, Formula 5 represents an initial condition, Formula 6 represents an equality constraint, and Formula 7 represents an inequality constraint.

A series of optimized control input can be derived in advance by solving the optimal control problems of Formulae 1 to 7 offline before starting control of the robot 2. On the other hand, when controlling the robot 2 in an unstructured environment, the state may not necessarily transit as estimated offline in advance due to an error of the kinetic model or an influence from disturbance.

Therefore, the present embodiment uses a control technique in which, in each control cycle Tₗ, assuming a robot state observed at the time as the initial condition presented by Formula 5, the movement control part 13 solves the optimal control problems of Formulae 1 to 7 for a period from the current time to to a time t_{f} that is a finite time ahead and uses only the results from to among obtained control inputs as a control instruction C. This technique is generally referred to as a model predictive control.

Although the following examples are described assuming a case of using a general model predictive control, it is possible to use another control technique associated with the optimal control problems of Formulae 1 to 7. For example, when the error of the kinetic model or the influence from the disturbance is extremely small and when the robot 2 is controlled on a simulator, a series of control inputs can be determined by the results of the optimal control problems of Formulae 1 to 7 solved offline. Otherwise, it is also possible to employ a hierarchical calculation method of calculating a force and a torque generated at a center of gravity of the robot 2 and then calculating the control input to be output to each articulation or rotor blade 22c, a method of obtaining some of parameters (e.g., weight matrix, evaluation period, target state) in the optimal control problems of Formulae 1 to 7 through machine learning, or the like. Moreover, the model predictive control includes a gradient-based technique using Differential Dynamic Programming, Multiple shooting method, and the like and a sampling-based technique using Monte Carlo method, path integral, and the like, and any of these techniques may be used. Furthermore, a value of time t_{f} in the optimal control problems of Formulae 1 to 7 is arbitrary, and setting a larger value allows for calculating the control instruction C considering the future state more. On the other hand, it is also possible to setting t_{f}=t₀+Tₗ for the control cycle Tₗ of the movement control part 13 and calculating the control instruction C taking into consideration only the next control input to the robot 2 and change of the state thereby.

In the following, as a specific example, description is given with reference to a case of applying the optimal control problems of Formulae 1 to 7 to the four-legged robot 2A. When the four-legged robot 2A is to be controlled, the kinetic model of Formula 4 may be represented as below.

$$\begin{matrix}[ Math . 8 ] & \\ {\dot{p}}_{com} = {\sum }_{i = 1}^{{n}_{l}} {f}_{l , i} + {\sum }_{i = 1}^{{n}_{a}} {f}_{a , i} + m g & Formula 8\end{matrix}$$

$$\begin{matrix}[ Math . 9 ] & \\ {\dot{l}}_{com} = {\sum }_{i = 1}^{{n}_{l}} ( {r}_{l , i} \times {f}_{l , i} + {τ}_{l , i} ) + {\sum }_{i = 1}^{{n}_{a}} ( {r}_{a , i} \times {f}_{a , i} + {τ}_{a , i} ) & Formula 9\end{matrix}$$

wherein p_{com}, l_{com} are functions that represent translational momentum and angular momentum of the center of gravity of the four-legged robot 2A and that depend on a position x_{b}, a rotation θ_{b}, a translational speed v_{b}, and a rotational speed ω_{b} of the base 22b, articulation angles θₗ and θₐ and articulation angular speeds ωₗ and ωₐ of the leg 22a and the arm 21. Furthermore, nₗ and nₐ are the numbers of contact points of the leg 22a and the arm 21, r_{l,i} and r_{a,i} are lengths from the center of gravity to contact points i of the leg 22a and the arm 21, f_{l,i} and f_{a,i} are contact forces generated at the contact points i of the leg 22a and the arm 21, T_{l,i} and T_{a,i} are contact torques generated at the contact points I of the leg 22a and the arm 21, and mg is a force generated at the center of gravity by the gravity force.

It should be noted that the way of describing the kinetic model is not limited to Formulae 8 and 9. For example, such a case can be employed that a term associated with centrifugal force or Coriolis force is added to Formula 8 to describe the kinetic model in more detail or that a term associated with inertia force of the leg 22a to reduce a computation amount.

Moreover, when the four-legged robot 2A is to be controlled, the equality constraint and the inequality constraint of Formulae 6 and 7 may be represented as below.

$$\begin{matrix}[ Math . 10 ] & \\ v \_ ( l , i ) = 0 & Formula 10\end{matrix}$$

(When leg contact point i is not in contact condition.)

$$\begin{matrix}[ Math . 11 ] & \\ μ {f}_{l , i}^{z} - \sqrt{{f}_{l , i}^{{x}^{2}} + {f}_{l , i}^{{y}^{2}}} ≧ 0 & Formula 11\end{matrix}$$

(When leg contact point i is not in contact condition.)

$$\begin{matrix}[ Math . 12 ] & \\ {f}_{l , i} = 0 & Formula 12\end{matrix}$$

(When leg contact point i is in contact condition.)

wherein v_{l,i} is a speed of the contact point i of the leg 22a, f_{l,i}^{x}, f_{l,i}^{y}, f_{l,i}^{z} are forces generated at the contact point i in tangential directions x, y and a normal direction z with respect to a contact surface. Formulae 10 and 11 define conditions that the contact point i does not slide on the contact surface. Moreover, the equality constraint of Formula 6 and the inequality constraint of Formula 7 can be added or deleted in accordance with performance and the target motion of the four-legged robot 2A. For example, the upper and lower limits of the articulation angle and the articulation angular speed of the leg 22a can be added as the inequality constraints.

By solving the optimal control problems of Formulae 1 to 7 using the kinetic model of Formulae 8 and 9 and the equality constraint and the inequality constraint of Formulae 10 to 12 in the case in which the four-legged robot 2A is to be controlled as described above, it is made possible to calculate such an articulation angle θₗ (or articulation angular speed ωₗ, articulation angular acceleration αₗ) of the leg 22a that any of the states x_{b}, v_{b}, θ_{b}, and ω_{b} of the base 22b of the four-legged robot 2A follows the target state x_{b,ref}, v_{b,ref}, θ_{b,ref}, or ω_{b,ref} and output the result to the moving part 22 as a movement control instruction C₂.

Now, when performing the model predictive control based on the optimal control problems of Formulae 1 to 7 in the actual environment, there can be a difference in the states of the four-legged robot 2A or the peripheral environment between a predicted value and a measured value due to the effect of the kinetic model or the disturbance. Thus, it is possible to feed back to the movement control part 13 information from a sensor provided to the four-legged robot 2A (e.g., an articulation state obtained from an encoder provided to the articulation of the leg 22a, a posture obtained from an inertia measurement unit provided to the base 22b, and the like) and use the information for correction of the control instruction C or as the initial condition of Formula 5.

Furthermore, by setting an arm state transition θₐ* (or articulation angular speed transition ωₐ*, articulation angular acceleration transition αₐ*) generated by the arm control part 12 as an articulation angle θₐ (or articulation angular speed ωₐ, articulation angular acceleration αₐ) of the arm 21 appearing in the kinetic model of Formulae 8 and 9, or by adding Formulae 13, 14, and 15 as equality constraints of Formula 6 in the optimal control problems of Formulae 1 to 7, it is made possible to generate the movement control instruction C₂ taking into consideration the effect of the inertia force of the arm 21.

$$\begin{matrix}[ Math . 13 ] & \\ {θ}_{a} = {θ}_{a}^{*} & Formula 13\end{matrix}$$

$$\begin{matrix}[ Math . 14 ] & \\ {ω}_{a} = {ω}_{a}^{*} & Formula 14\end{matrix}$$

$$\begin{matrix}[ Math . 15 ] & \\ {α}_{a} = {α}_{a}^{*} & Formula 15\end{matrix}$$

There can be a case in which any of Formulae 13, 14, and 15 is omitted. If load is applied to the end effector 21a of the arm 21, it is also possible to add an equality constrain associated with a force fa generated in the end effector 21a. At this point, in the process that the arm control part 12 calculates the arm control instruction C₁, in a case in which the arm control part 12 can obtain the arm state transition θₐ* in the evaluation period [t₀,t_{f}] such as, for example, a case in which the arm control part 12 uses the model predictive control or uses learning-type control based on prediction of an environmental state, the obtained arm state transition θₐ* can be output to the movement control part 13 as it is. On the other hand, in the process that the arm control part 12 calculates the arm control instruction C₁, in a case in which the arm control part 12 does not obtain the arm state transition θₐ* in the evaluation period [t₀,t_{f}], for example, the arm control part 12 can estimate the arm state transition θₐ* by extrapolating a future control instruction C_{F} with reference to a control instruction C_{P} in the past.

Setting a weight Qᵢ of a state variant xᵢ appearing in Formula 2 to be larger in the optimal control problems of Formulae 1 to 7 can increase followability of the state variant xᵢ with respect to a target state x_{i,ref}. On the other hand, with the optimal control problem based on the set parameter (e.g., weight matrix, evaluation period, target state, and the like), it may not be possible to derive the solution to have the state of the moving part 22 follow the target state. In that case, the state of the moving part 22 may deviate from the target state leading to failure of the target motion of the arm 21, or the moving part 22 may not be able to keep a stable posture to fall down. Otherwise, even if the state of the moving part 22 can follow the target state, there may be a large load applied to the articulation of the leg 22a for the moving part 22 to retain the target state, resulting in consumption of excessive power or early degradation of the driving part. A method of adjusting a parameter in advance so that the state of the moving part 22 can follow the target state and the load on the driving part is reduced is also conceivable.

However, in a situation in which full information about the state of the operation object or the peripheral environment is not available in advance or in which their state may dynamically change, it is difficult to prepare an effective parameter for every situation in advance. Moreover, it is also not practical to perform an arithmetic operation online in real time during control of the robot 2.

To solve this problem, the present embodiment proposes the following method of setting an allowable range in advance with respect to a state variant in the optimal control problems of Formulae 1 to 7 based on characteristics of the target motion of the arm 21.

In the first place, in performing the target motion of the arm 21, it is not essential for the state of the moving part 22 to strictly follow the target state. For example, in a case in which the target motion is processing of the operation object and the required quality is satisfied if only the result of the processing is within a certain range, it suffices to control the moving part 22 to perform the processing within the range. Moreover, also in a case in which the arm control part 12 controls the arm 21 based on a feedback of information of the sensor provided to the robot 2, if only the state of the moving part 22 is within the certain range, the arm control instruction C₁ may be corrected on the bases of the difference between the actual state and the target state of the moving part 22 to achieve the target motion.

Accordingly, by considering the characteristics of the target motion of the arm 21, it is made possible to set the allowable range for achieving the target motion of the arm 21 in advance with respect to the state variant. This makes it possible to select the state of the moving part 22 within a range that satisfies the allowable range and increases a probability of deriving the solution to achieve the target motion of the arm 21. Furthermore, it can be expected to reduce the load on the power consumption or the driving part when controlling the moving part 22.

Examples of the method of setting the allowable range for the state variant x to achieve the target motion of the arm 21 are, for example, the following two.

A first allowable range setting method is a method in which the following formula is added as the inequality constraint of Formula 7 in the optimal control problems of Formulae 1 to 7.

$$\begin{matrix}[ Math . 16 ] & \\ {x}_{i , min} ≦ {x}_{i} ≦ {x}_{i , max} & Formula 16\end{matrix}$$

wherein, xᵢ is a state variant for setting an allowable range, and xₘᵢₙ and xₘₐₓ are a lower limit and an upper limit of xᵢ required for achieving the target motion of the arm 21. At this point, the state variant xᵢ may be a variant other than the state of the moving part 22. For example, the position or the posture of the contact point of the arm 21 may be set as the state variant xᵢ. Moreover, the allowable range of Formula 13 may be set with respect to a plurality of state variants. It should be noted that the lower limit xₘᵢₙ and the upper limit xₘₐₓ may be input by a user via the allowable range input part 31 or may be automatically generated by the motion planning part 11 using machine learning or the like.

A second allowable range setting method is a method of adjusting the weight matrix in the evaluation function of Formula 2 in the optimal control problems of Formulae 1 to 7. For example, since the followability to the target state x_{i,ref} can be reduced by reducing the weight Qᵢ associated with the state variant xᵢ, it is possible to derive the movement control instruction C₂ capable of achieving the target motion of the arm 21 by setting Qᵢ so that Formula 13 is satisfied when the optimal control problems of Formulae 1 to 7 is solved. It should be noted that the weight Qᵢ in this case may be input by the user via the allowable range input part 31 or may be automatically generated by the motion planning part 11 using machine learning or the like.

Moreover, it is also possible to combine these two allowable range setting methods. For example, it is possible to adjust easiness of change of xᵢ within the set allowable range using Qᵢ after explicitly setting the allowable range of Formula 13 with respect to xᵢ.

Although the specific example was described with reference to the four-legged robot 2A in the present embodiment, the example can be extended to a case in which the robot 2 is the humanoid robot 2B or the unmanned aerial vehicle 2C by replacing the kinetic model in Formula 4 or the equality constraint and the inequality constraint in Formulae 6 and 7 in accordance with the form of the robot 2.

For example, when controlling the humanoid robot 2B, the kinetic models of Formulae 8 and 9 and the constraint conditions of Formulae 10, 11, and 12 as they are by setting the number of contacts in the leg 22a and the arm 21 to nₗ and nₐ and handling the base 22b and its head collectively as a body.

Moreover, when controlling the unmanned aerial vehicle 2C, it suffices to represent the kinetic model of Formula 4 with a translational motion equation (Formula 17) in an inertial system and a rotational motion equation (Formula 18) in a body frame with its origin at the center of gravity of the unmanned aerial vehicle 2C.

$$\begin{matrix}[ Math . 17 ] & \\ {\dot{p}}_{com} = {RF}_{w} + {\sum }_{i = 1}^{{n}_{a}} {f}_{a , i} + m g & Formula 17\end{matrix}$$

$$\begin{matrix}[ Math . 18 ] & \\ {\dot{l}}_{com} = {τ}_{w} + {\sum }_{i = 1}^{{n}_{a}} ( {r}_{a , i} \times {f}_{a , i} + {τ}_{a , i} ) & Formula 18\end{matrix}$$

wherein, p_{com}, l_{com} are functions that represent the translational momentum and the angular momentum of the center of gravity of the unmanned aerial vehicle 2C and that depend on the position x_{b}, the rotation angle θ_{b}, the translational speed v_{b}, and the rotational speed ω_{b} of the base 22b and the articulation angle θₐ and the articulation angular speed ωₐ of the arm 21. Furthermore, nₐ is the number of the contact points of the base 22b, r_{a,i} is the length from the center of gravity to the contact point i of the arm 21, f_{a,i} is the contact force generated at the contact point i of the arm 21, τ_{a,i} is the contact torque generated at the contact point i of the arm 21, and mg is the force generated at the center of gravity by the gravity force. Moreover, R is a rotation matrix for transforming from the body frame to the inertial system, and F_{w} and τ_{w} are the thrust and the torque generated to the unmanned aerial vehicle 2C by the rotation of the rotor blade 22c. The thrust F_{w} and the torque τ_{w} are proportional to a square of the number of rotations ω_{b} of the rotor blade 22c.

It should be noted that the way of describing the kinetic model of the unmanned aerial vehicle 2C is not limited to Formulae 17 and 18, and it is possible, for example, to add a term associated with air resistance to the translational motion equation of Formula 17,or to add a term associated with viscous resistance of the air to the rotational motion equation of Formula 18. Moreover, although the constraint condition of Formulae 6 and 7 does not necessarily have to be given, for example, the upper limit of the number of rotations ω_{w} of the rotor blade 22c can be given as the inequality constraint of Formula 7.

As described above, by solving the optimal control problems of Formulae 1 to 7 using the kinetic models of Formulae 17 and 18, it is made possible to calculate the number of rotations ω_{w} (or the thrust of each rotor blade 22c, such an angular speed of each rotor blade 22c, or the like) of the rotor blade 22c of the unmanned aerial vehicle 2C that any of the states x_{b}, v_{b}, θ_{b}, and ω_{b} of the base 22b follows the target states x_{b,ref}, v_{b,ref}, θ_{b,ref}, ω_{b,ref} and output the result to the moving part 22 as the moving part control instruction.

### <Specific Operation of Robot Control System of the Present Embodiment>

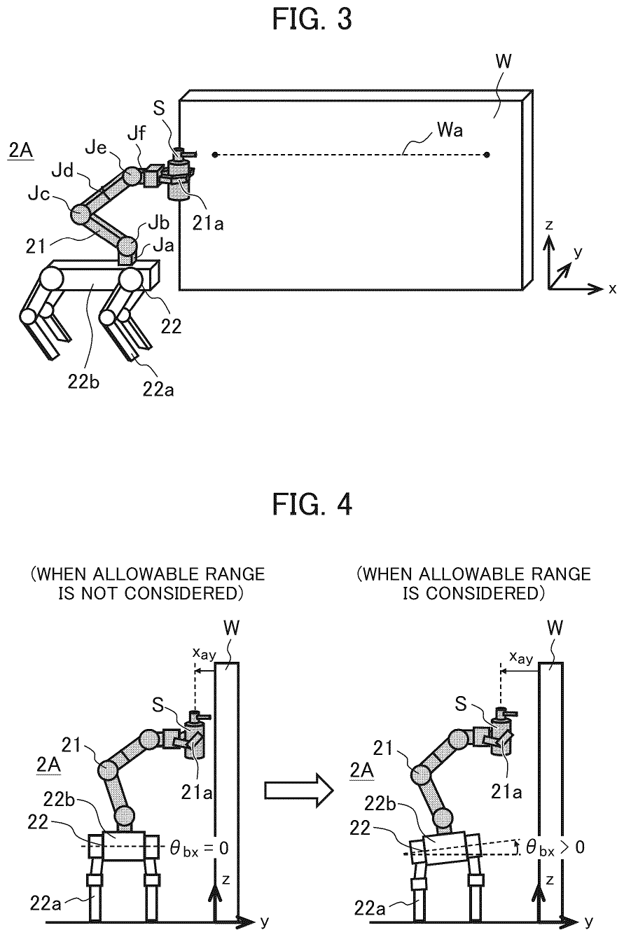

Next, a specific operation of the robot control system 100 in a case in which the robot 2 is the four-legged robot 2A is described with reference to FIGS. 3 to 6.

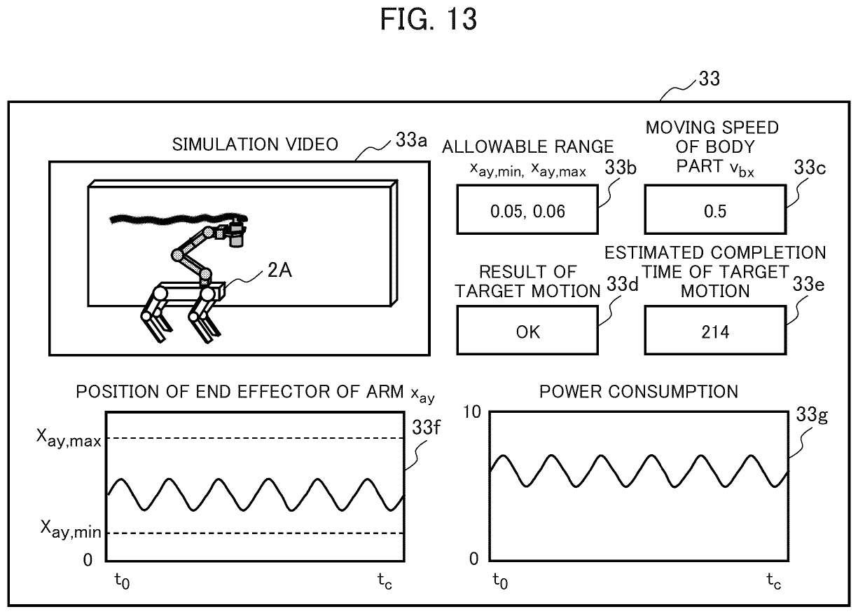

FIG. 3 illustrates a target motion of the robot 2 (four-legged robot 2A) coating a coating area Wa of a wall surface W with a coating spray S held by the arm 21 while moving in a horizontal direction (x-axis direction) with respect to the wall surface W. In the following, the way to determine the allowable range to achieve the target motion and a method of setting the allowable range to the optimal control problems of Formulae 1 to 7 as the inequality of FIG. 13 are described taking the target motion in FIG. 3 as an example.

To achieve the target motion shown in FIG. 3, the arm control part 12 of the control device 1 firstly provides to the arm 21 of the robot 2 control instructions for articulations Ja to Jd, Jf of the arm 21 to retain the initial state in FIG. 3. For the remaining articulation Je, the control instruction is provided so that the injection direction of the coating spray S constantly faces a depth direction (y-axis direction) with respect to the wall surface W based on the feedback of the sensor information (posture information of the base 22b, visual sensor information, and the like). This target motion can be achieved by the moving part 22 moving in the horizontal direction (x-axis direction) with respect to the wall surface W under the arm control instruction C₁ combining the aforementioned control instructions. Here, as long as a distance from an injection port of the coating spray S to the wall surface W is within a predetermined range, the sprayed coating material shall not be diffused and the required quality of the target motion shall be satisfied.

To satisfy the required quality of the target motion, a target posture can be set with respect to the posture (x_{bx}, x_{by}, x_{bz}, θ_{bx}, θ_{by}, θ_{bz}) of the base 22b of the robot 2 so as to satisfy (x_{bx,ref}, x_{by,ref}, x_{bz,ref}, θ_{bx,ref}, θ_{by,ref}, θ_{bz,ref})=(v_{x,0t}, x_{by,0}, x_{bz,0}, θ_{bx,0}, θ_{by,0}, θ_{bz,0}). In the above-described expressions, x_{bx,ref} represents a target posture so that the base 22b moves in the x direction at a constant speed vₓ₀, and others represent target postures to retain their initial values.

In addition, to satisfy the required quality of the target motion of coating, x_{ay,min}<x_{ay}<x_{ay,max} can be set to a position x_{ay} of the end effector 21a of the arm 21 in the y direction as the inequality constraint of Formula 13. Here, as long as the required quality is satisfied, the inequality constraint of Formula 13 may be set to other state variants such as the position or the posture of the base 22b. Moreover, in a case in which coating shift in a vertical direction (z direction) of the wall surface W is allowable, an inequality constraint x_{az,min}<x_{az}<x_{az,max} can be set with respect to a position x_{az} in the z direction of the end effector 21a of the arm 21. Otherwise, assuming that the diffusion of the coating material due to change in x_{ay} can influence the coating shift with respect to the vertical direction of the wall surface W, x_{ay-z,min}<Ax_{ay}+Bx_{az}<x_{ay-z,max} can be set as the inequality constraint. In the above-described expression, A and B are constants of proportionality.

A procedure of achieving the target motion with the robot control system 100 shown in FIG. 1 is described below.

First, the motion planning part 11 instructs the arm control part 12 to perform the target motion. At the same time, the motion planning part 11 outputs the target posture with respect to the base 22b and the allowable range with respect to the position of the end effector 21a of the arm 21 to the movement control part 13.

Subsequently, the arm control part 12 outputs the arm control instruction C₁ for achieving the target motion to the atm 21 at a control cycle Tₐ. At the same time, the arm control part 12 outputs information about the arm state transition θₐ* to the movement control part 13. In a case of this target motion, it is possible to output the information about the state of the articulation J of the arm 21 that does not change over time as the information about the arm state transition θₐ*. At this time, although the actual control is performed to change an angle of the articulation Je of the arm 21 based on the feedback of the sensor information, it is assumed that the change in the inertial force due to the change in the angle of the articulation Je is small and its influence to the dynamics of the moving part 22 is small.

Then, the movement control part 13 calculates the movement control instruction C₂ that follows the target posture of the base 22b while considering the information about the arm state transition θₐ* using the model predictive control based on the optimal control problems of Formulae 1 to 7, and outputs the result to the moving part 22 at a control cycle Tb. This allows the moving part 22 to be appropriately controlled on the basis of the information about the arm state transition θₐ*.

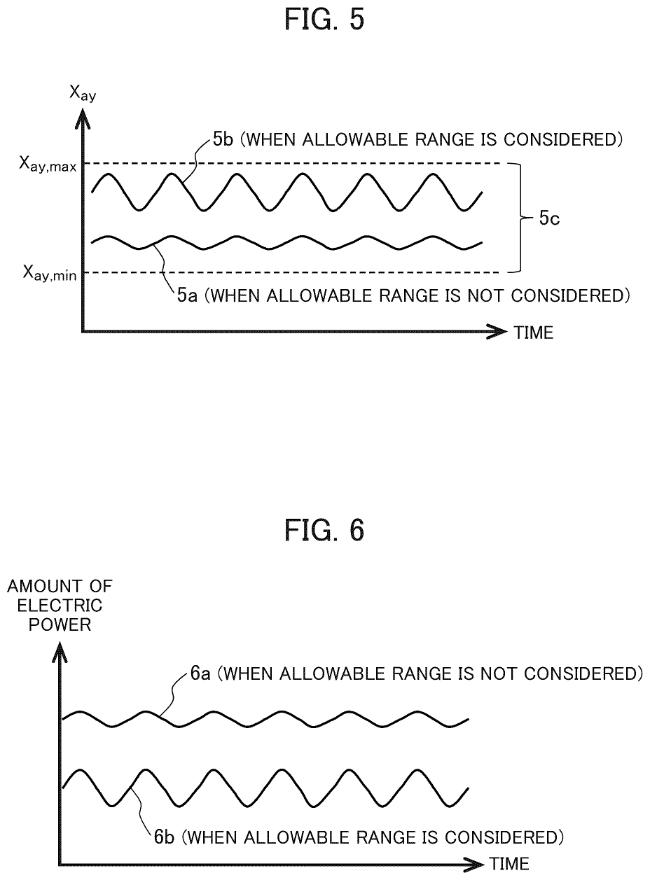

FIGS. 4 to 6 illustrate control results when controlling the robot 2 to perform the target motion in FIG. 3. FIG. 4 is a schematic view of the robot 2 and the peripheral environment, FIG. 5 shows the time change in the position x_{ay} of the end effector 21a of the arm 21, and FIG. 6 shows the time change in the amount of electric power output to a motor that drives the articulation of the leg 22a.

### <<Case Where the Present Invention is Not Applied (Allowable Range is Not Considered)>>

First, a robot control result in a case in which the movement control part 13 of the control device 1 does not consider an allowable range for the position x_{ay} of the end effector 21a is described. In this case, as shown in the left view of FIG. 4, the base 22b continues to retain its initial posture by the posture of the base 22b of the robot 2 following the target posture. This allows the position x_{ay} of the end effector 21a to fall within an allowable range 5c as indicated by a result 5a of the case in which the allowable range is not considered in FIG. 5.

However, in the state of the left view of FIG. 4, the center of gravity of the arm 21 of the robot 2 is located in a more forward direction on the y axis than the center of gravity of the moving part 22, and the arm 21 in this state generates a moment that rotates the moving part 22 around the x axis. Therefore, if the posture of the base 22b is retained as the target posture against the moment, as indicated by a result 6a of the case in which the allowable range is not considered in FIG. 6, the power consumption of the motor that drives the articulation of the leg 22a is increased. In this manner, controlling the robot 2 without considering the allowable range for the end effector position may result in consumption of excessive power in the robot 2 or early degradation of the articulation of the leg 22a.

### <<Case Where the Present Invention is Applied (Allowable Range is Considered)>>

Next, the control result in a case in which the movement control part 13 of the control device 1 considers the allowable range for the position x_{ay} of the end effector 21a. In this case, although the posture of the base 22b of the robot 2 is rotated in the direction of θ_{bx} as shown in the right view of FIG. 4, the position x_{ay} of the end effector 21a can be within the allowable range 5c as indicated by a result 5b of the case in which the allowable range is considered in FIG. 5.

At this point, as shown in the right view of FIG. 4, the position of the center of gravity of the arm 21 can be substantially aligned with the position of the center of gravity of the moving part 22 on the y axis by rotating the posture of the base 22b of the robot 2 in the direction of θ_{bx}. This can suppress the moment around the x axis derived from the arm 21, and can reduce the power consumption of the motor that drives the articulation of the leg 22a as indicated by a result 6b of the case in which the allowable range is considered in FIG. 6. As a result, it is possible to reduce the amount of power consumption and the load on the articulation of the leg 22a to achieve the target motion.

Although spray coating is used as the target motion in FIGS. 3 to 6 described above, the allowable range can be set in a similar procedure even if the target motion is changed to coating with a roller or brush, polishing, welding, wiping, or the like. In a case of polishing and wiping, since the end effector 21a of the arm 21 needs to be in contact with the wall surface W, an adjustment is required such as setting the allowable range to be smaller for the position x_{ay} in the normal direction (y direction) with respect to the wall surface W. Moreover, in a case in which contacting with the wall surface W causes an external force to the end effector 21a of the arm 21, it is possible to control the moving part taking into consideration the external force generated in the arm 21, by obtaining the external force using a force sensor provided to the arm 21 and setting the external force to fₐ appearing in the kinetic model of Formula 9.

As described above, according to the robot control system of the present embodiment, it is possible to easily obtain an appropriate moving part control law even when there are many combinations of the arm states and the moving part states to achieve the target motion by setting the allowable range for the state variant in advance.

### Second Embodiment

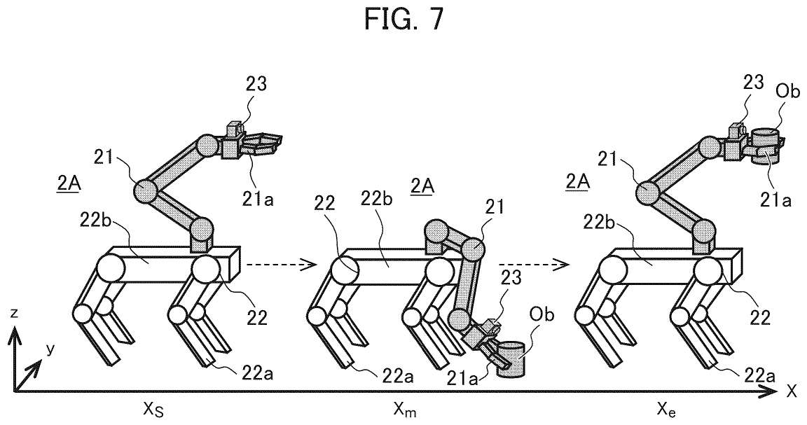

Next, the robot control system 100 according to Second embodiment of the present invention is described with reference to FIGS. 7 to 11. It should be noted that features common with First Embodiment are not described again.

FIG. 7 illustrates a target motion of the robot 2 (four-legged robot 2A) moving along the x axis from a position xₛ and gripping an operation object Ob at a position xₘ with the arm 21 upon passing nearby the operation object Ob. In this embodiment, the way to determine the allowable range to achieve the target motion and a method of setting the allowable range to the optimal control problems of Formulae 1 to 7 as the inequality of FIG. 13 are described taking the present target motion as a specific example and in a case where the allowable range changes on the basis of the state of the arm 21.

To achieve the target motion, the arm control part 12 firstly recognizes the state of the operation object Ob from image information I₁ of the peripheral environment imaged by a camera 23 included in the robot 2. Consequently, a future track of the operation object Ob is predicted on the basis of time series information about the operation object Ob and the target track of the arm 21 for gripping the operation object Ob is generated. This is equivalent to the method of controlling the arm 21 for gripping the operation object Ob moving on a belt conveyor or the like. Therefore, the existing control technique for the arm 21 can be used for controlling the arm control part 12 as it is by moving the moving part 22 connected to the arm 21 instead of moving the operation object Ob.

Here, the arm control part 12 shall be able to evaluate from the time series image information I₁ of the operation object Ob captured by the camera 23 whether the arm 21 can grip the operation object Ob when the moving part 22 moves from the current position at a certain speed. In that case, it shall be possible to determine an upper limit v_{bx,max} of the speed of the moving part 22 for the arm 21 to grip the operation object Ob. At this point, the shorter a distance rₐ₋ₒ between the end effector 21a of the arm 21 and the operation object Ob is, the smaller v_{bx,max} becomes, because it becomes difficult to forestall the end effector 21a of the arm 21 in accordance with a predicted track of the operation object Ob. Thus, because v_{bx,max} changes depending on rₐ₋ₒ, the allowable range set to achieve the target motion also changes on the basis of rₐ₋ₒ.

As described above, the target posture at a time t+Δt with respect to the posture (x_{bx}, x_{by}, x_{bz}, θ_{bx}, θ_{by}, θ_{bz}) of the base 22b can be set as (x_{bx,ref}, x_{by,ref}, x_{bz,ref}, θ_{bx,ref}, θ_{by,ref}, θ_{bz,ref})=(x_{bx,t}+v_{bx,max}(t)Δt, x_{by,0}, x_{bz,0}, θ_{bx,0}, θ_{by,0}, θ_{bz,0}). Here, x_{bx,t} is the position of the base 22b on the x axis at the time t, and v_{bx,max}(t) is the upper limit of the speed of the moving part 22 at the time t. In addition, the allowable range for the arm 21 to grip the operation object Ob can be set as v_{bx,min<}v_{bx<}v_{bx,max} as the inequality constraint of Formula 13 with respect to the translational speed v_{bx} of the base 22b. Here, any speed lower than v_{bx,max} may be set for v_{bx,min}. In this case, v_{bx,min}=v_{bx,max}/2 is set to guarantee the minimum moving speed.

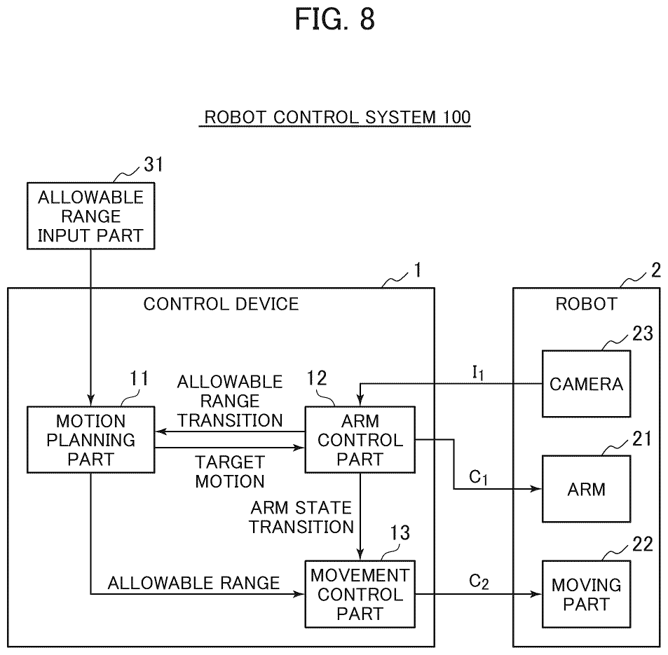

FIG. 8 illustrates a configuration of the robot control system 100 to achieve the target motion. A procedure of achieving the target motion with the robot control system 100 shown in FIG. 8 is described below.

First, the motion planning part 11 instructs the arm control part 12 to perform the target motion. Next, the arm control part 12 generates the arm control instruction C₁ based on the image information I₁ imaged by the camera 23 and outputs the arm control instruction C₁ to the arm 21 at the control cycle Tₐ. At the same time, the arm control part 12 generates the arm state transition θₐ* and the transition of the allowable range v_{bx,max} based thereon and outputs the arm state transition θₐ* to the movement control part 13 and the allowable range transition to the motion planning part 11. The arm state transition θₐ* can be generated, for example, assuming that the operation object Ob moves at a constant speed, by predicting the target track to be taken by the arm 21 in the future.

Subsequently, the motion planning part 11 determines the target posture with respect to the posture of the base 22b and the allowable range for v_{bx} on the basis of the allowable state transition and outputs the them to the movement control part 13. The movement control part 13 then calculates the movement control instruction C₂ that follows the target posture of the base 22b considering the information about the arm state transition θₐ* and using the model predictive control based on the optimal control problems of Formulae 1 to 7, and outputs the result to the moving part 22 at the control cycle T_{b}. At this point, if the movement control instruction C₂ changes, the position of the operation object Ob captured by the camera 23 also changes, and therefore the arm control instruction C₁ generated by the arm control part 12 is modified. Therefore, in the process that the movement control part 13 calculates the movement control instruction C₂ based on the optimal control problems of Formulae 1 to 7, the arm state transition θₐ* is changed.

To take a correct arm state transition θₐ* into consideration, it is also possible to successively modify the arm state transition θₐ* in the process of the optimization calculation with the optimal control problems of Formulae 1 to 7. For example, the arm state transition θₐ* can be modified at a low calculation cost by approximating the arm state as a function pertaining to the distance rₐ₋ₒ between the end effector 21a of the arm 21 and the operation object Ob. On the other hand, when using the model predictive control, because the calculation of the movement control instruction C₂ based on the updated arm state transition θₐ* is performed at the control cycle T_{b}, it is possible to calculate the movement control instruction C₂ that does not largely deviate from an optimal solution even if the arm state transition θₐ* is not correct to some extent.

Here, in a case in which the control cycle Tₐ of the arm control part 12 and the control cycle T_{b} of the movement control part 13 are different from one another, update cycles of the arm state transition θₐ* and the allowable range transition may be either of Tₐ or T_{b}. The cycle at which the motion planning part 11 outputs the target posture and the allowable range to the movement control part 13 may be equal to Tₐ or T_{b} or may be any other cycle.

There is a possible case in which the arm control part 12 cannot perform the target motion because the distance between the robot 2 and the operation object Ob is too large. In that case, it is possible to employ a method of feeding back the image information I₁ of the camera 23 to the motion planning part 11 and starting an instruction of the target motion to the arm control part 12 at a timing at which the distance between the robot 2 and the operation object Ob is reduced below a certain reference value. At this point, it is possible to instruct the target position or the target posture to the movement control part 13 so as to move toward the operation object Ob at a certain speed until starting the instruction of the target motion with respect to the arm control part 12.

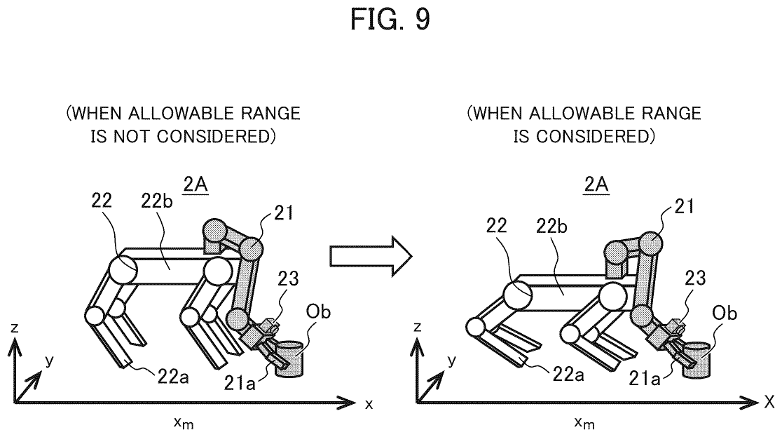

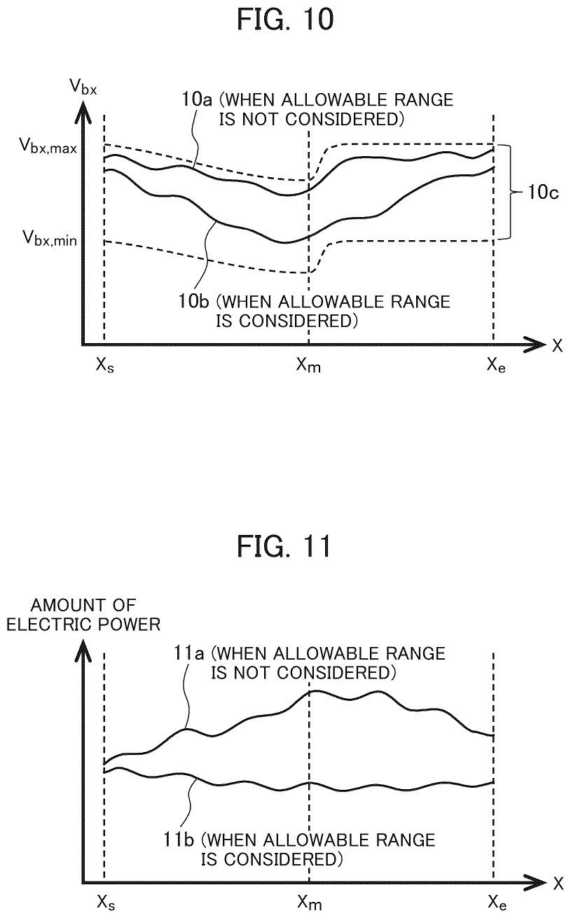

FIGS. 9, 10, and 11 illustrate the control result of controlling the robot 2 toward the target motion. FIG. 9 is a schematic view of the robot 2 and the peripheral environment, FIG. 10 shows the transition of translational speed v_{bx} of the base 22b, and FIG. 11 shows the transition of the amount of electric power output to a motor that drives the articulation of the leg 22a.

### <<Case Where the Present Invention is Not Applied (Allowable Range is Not Considered)>>

First, a control result 10a in a case in which the movement control part 13 of the control device 1 does not consider the allowable range for the translational speed v_{bx} of the base 22b is described. The arm 21 can grip the operation object at the position xₘ by the posture of the base 22b of the robot 2 follows the target posture as shown in the left view of FIG. 9. On the other hand, as the arm 21 of the robot 2 approaches the operation object Ob, the position of the center of gravity of the robot 2 moves in a negative direction with respect to the y axis. This increases the amount of electric power to be output to the motor that drives the articulation of the leg 22a for the posture of the base 22b to follow the target posture, as indicated by a result 11a of the case in which the allowable range is not considered in FIG. 11. Thus, there is a risk of excessive power consumption or early degradation of the articulation of the leg 22a.

### <<Case Where the Present Invention is Applied (Allowable Range is Considered)>>

Next, a control result 10b in a case in which the movement control part 13 of the control device 1 considers the allowable range for the translational speed v_{bx} of the base 22b is described. It is noted here that, in addition to the allowable range for the moving speed v_{bx} of the base 22b, x_{bz,min}<x_{bz}<x_{bz,max} is given as an allowable range for the position x_{bz} of the base 22b in the z direction. As compared to the case in which the allowable range is not considered as shown in the left view of FIG. 9, the posture of the base 22b moves more in the negative direction with respect to the z axis in the case in which the allowable range is considered in the right view of FIG. 9. Since this moves the position of the center of gravity of the arm 21 further in the positive direction with respect to the y axis, the amount of electric power output to the motor that drives the articulation of the leg 22a is reduced as indicated by a result 11b of the case in which the allowable range is considered in FIG. 11. As a result, it is possible to reduce the amount of power consumption or the load on the articulation of the leg 22a. At this point, although the moving speed v_{bx} is smaller as indicated by the result 10b in the case in which the allowable range is considered in FIG. 10 in order to walk with the position x_{bz} of the base 22b in the z direction kept lower, the moving speed v_{bx} is still within an allowable range 10c.

Although gripping of a static object is taken as an example of the target motion in this embodiment, the allowable range can be set in a similar procedure target motion is replaced by gripping of a dynamic object, installation of the gripped object, or pressing of a switch button. Moreover, in a case in which an external force is applied to the end effector 21a of the arm 21 by gripping of the operation object Ob or contact with the peripheral environment, it is possible to control the moving part taking into consideration the external force generated in the arm 21 such as by measuring the external force with the force sensor included in the arm 21 and setting the measurement to fₐ appearing in the kinetic model of Formula 9. Otherwise, it is also possible to describe the state transition of the operation object Ob and the peripheral environment in the kinetic model of Formula 9 and thereby considering their behaviors more correctly.

Moreover, the system of this embodiment including the camera 23 can determine the target state of the base 22b and the target position of the contact point of the leg 22a by feeding back the information from the camera 23 to the movement control part 13 and thereby recognizing obstacles and geographical features in the peripheral environment.

### Third Embodiment

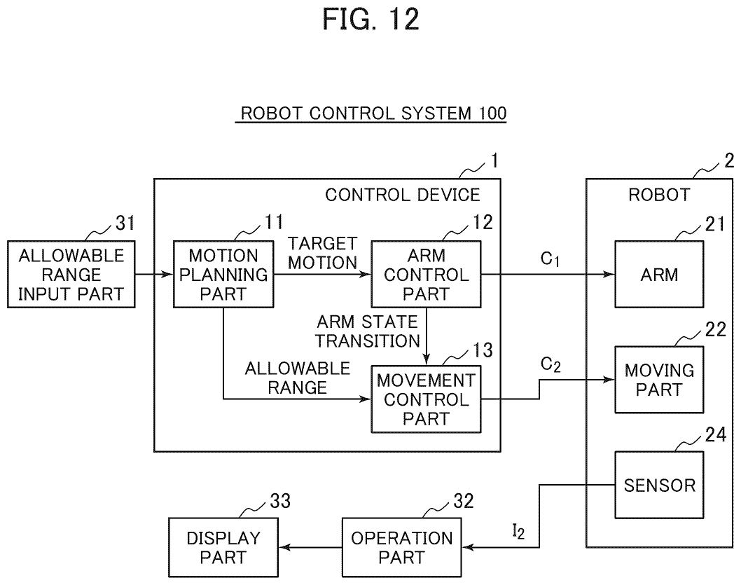

Next, the robot control system 100 according to Third Embodiment of the present invention is described with reference to FIGS. 12 to 13. In this embodiment, a system including an assistance function for determining the allowable range to achieve the target motion of the arm 21 is described. It should be noted that features common with the aforementioned embodiments are not described again.

FIG. 12 illustrates a configuration of the robot control system 100 according to the present embodiment. This robot control system 100 includes a sensor 24, an operation part 32, and a display part 33 in addition to the configuration of the robot control system shown in FIG. 1.

At the allowable range input part 31, information about the allowable range is input by the user via a keyboard, a touch panel, a joystick, or the like, and the information about the allowable range is output to the motion planning part 11. Specifically, the information is input as a weight matrix in the inequality constraint of Formula 13 and the optimal control problem in Formulae 1 to 3 with respect to a state variant. At this point, the values input as the upper and lower limits in the inequality of Formula 13 may be a constant like the allowable range for the target motion in First Embodiment or may be a function that depends on a certain variant.

The operation part 32 obtains a result of the robot 2 having been controlled under the information about the input allowable range by the information from the sensor 24, and computes information to be presented to the user based on the obtained information. It should be noted that the operation part 32 is a function part achieved by a computer different from the computer that constitutes the control device 1 or a function part achieved by the same computer as the control device 1.

The display part 33 is a display device such as a liquid crystal display that displays the information computed by the operation part 32. FIG. 13 shows an example of the information displayed on the display part 33. Here, FIG. 13 assumes a case in which the robot 2 (four-legged robot 2A) performs the target motion shown in FIG. 3. The user can confirm a simulation video 33a when the robot 2 operates under an allowable range 33b to be set, a temporal change 33f of the state variant to which the allowable range is set, and a temporal change 33g of the power consumption.

If the state variant to which the allowable range is set does not fall in the allowable range 33b, if the robot 2 falls down while performing the target motion, or if the robot 2 runs out of power before achieving the target motion, NG is displayed on a result of target motion 33d and the user can correct the allowable range 33b based on the information. It is also possible to correct the allowable range or the target state pertaining to a moving speed 33c of the base 22b output from the motion planning part 11 to the moving part control part 13 on the basis of the information about the moving speed 33c of the body or an estimated completion time 33e of the target motion displayed on the display part 33. At this point, the configuration of the display part 33 is not limited to what is shown in FIG. 13 but other cases are also conceivable such as additionally displaying a control instruction value to the arm 21 or the moving part 22, omitting to display any of the information shown in FIG. 13, or adding an interface that allows for selecting information to be displayed. It is also possible for the operation part 32 to compute an appropriate allowable range based on the information from the sensor 24 and present it on the display part 33. Alternatively, it is possible to output the computed allowable range directly to the motion planning part 11.

The configuration of the robot control system 100 in FIG. 12 can be applied to both cases in which the robot 2 is controlled in the actual environment and in the virtual environment. In the case in which the robot 2 is controlled in the actual environment, more realistic verification of the allowable range can be performed in relation to an operation using an actual machine. On the other hand, in the case in which the environmental condition for the actual operation is uncertain, it requires a lot of labor to comprehensively evaluate the uncertain environmental condition. Moreover, if the target motion fails, the robot 2 may possibly interfere with the peripheral environment resulting in damage. To the contrary, in the case in which the robot 2 is controlled in the virtual environment, it is possible to determine the information about the allowable range upon evaluating robustness against various environmental conditions without using an actual machine.

### Fourth Embodiment

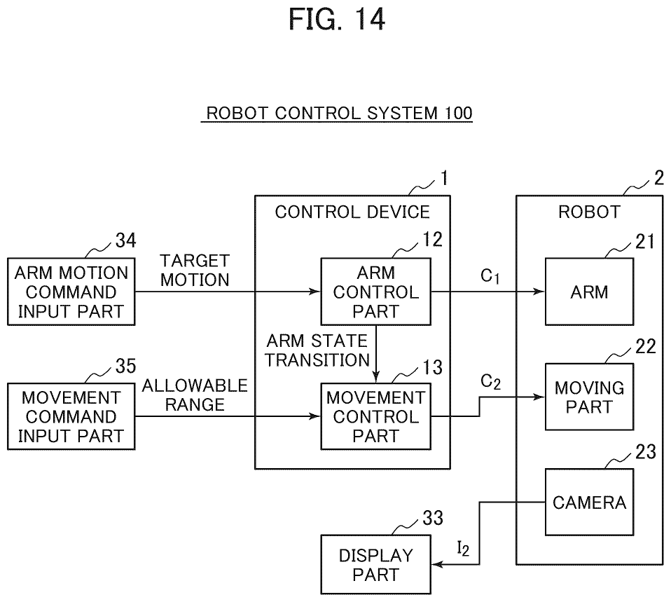

Next, the robot control system 100 according to Fourth Embodiment of the present invention is described with reference to FIG. 14. In this embodiment, description is given with reference to a case in which the arm 21 is controlled by the user. It should be noted that features common with the aforementioned embodiments are not described again.

FIG. 14 illustrates a configuration of the robot control system 100 according to the present embodiment. At an arm motion command input part 34, an arm motion command (position and posture of the end effector 21a of the arm 21, angle of each articulation of the arm 21, and the like) is input by an input device (joystick, slave robot, keyboard, and the like). At the arm control part 12, the arm control instruction C₁ (articulation angle, articulation angular speed, articulation torque, and the like) that satisfies the arm motion command is generated and output to the arm 21 at the control cycle Tₐ. At the same time, the arm state transition θₐ* is estimated and output to the movement control part 13. The method by which the arm control part 12 generates the arm state transition θₐ* at this point is arbitrary. For example, it is possible to employ a method of predicting the arm state transition θₐ* by linear extrapolation or machine learning using the past information of the arm control instruction C₁.

At a movement command input part 35, the movement command (position, posture, translational speed, and the like of the base 22b) and the allowable range represented as the inequality constraint of Formula 13 are input by the allowable range input part 31. At the movement control part 13, the movement control instruction C₂ taking the arm state transition θₐ* into consideration is calculated using the optimal control problems of Formulae 1 to 7 based on the moving part motion command and the allowable range, and output to the moving part 22 at the control cycle T_{b}.

In this embodiment, because the arm motion command is input by the user, the allowable range to achieve the target motion depends on an operation of the user. For example, a target motion is assumed in which an instrument is imaged with the camera 23 included in the arm 21 by the user operating the arm 21 while the moving part 22 of the robot 2 is moving at a constant speed and the user reads information of the instrument from an image taken by the camera 23 displayed on the display part 33. In this case, as the base 22b of the robot 2 vertically vibrates on a large scale during movement, the information of the instrument cannot be correctly read from the image taken by the camera 23. Thus, achievement of such a target motion that improves image quality of the camera 23 can be assisted by the user modifying the allowable range for the vertical vibration based on the image quality of the camera 23 displayed on the display part 33 and inputting the result to the movement command input part 35.

Although instrument reading is taken as an example of the target motion in this embodiment, the allowable range can be set in a similar procedure even if the user operates the arm 21 on the basis of the target motion such as gripping, installation, passing, throwing of the operation object, or pressing of the switch button.

### LIST OF REFERENCE SIGNS

100: robot control system
1: control device
11: motion planning part
12: arm control part
13: movement control part
2: robot
21: arm
21a: end effector
22: moving part
22a: leg
22b: base
22c: rotor blade
23: camera
24: sensor
31: allowable range input part
32: operation part
33: display part
34: arm motion command input part
35: movement command input part

1. A robot control system comprising:
a robot including an arm and a moving part; and
a control device that controls the robot,
wherein the control device includes:
a motion planning part that outputs a target motion of a motion of the arm and an allowable range for the motion of the moving part corresponding to the target motion;
an arm control part that outputs an arm control instruction associated with the target motion and an arm state transition; and
a movement control part that generates a movement control instruction associated with a motion of the moving part to fall within the allowable range using the arm state transition, and
wherein the robot has the arm controlled by the arm control instruction and has the moving part controlled by the movement control instruction.

2. The robot control system according to claim 1,
wherein the motion planning part generates a target track of a motion of the moving part within the allowable range, and
wherein the movement control part generates the movement control instruction so as to decrease a difference from the target track.

3. The robot control system according to claim 1,
wherein the moving part of the robot includes a leg or a rotor blade, and
wherein the movement control part generates the movement control instruction associated with a state of an articulation of the leg or the rotor blade.

4. The robot control system according to claim 1,
wherein the arm control part generates the arm state transition by predicting a future arm control instruction using a state transition of the arm control instruction.

5. The robot control system according to claim 1,
wherein the allowable range is generated by setting at least one of a lower limit and an upper limit to a state of the moving part or an end effector of the arm.

6. The robot control system according to claim 5,
wherein the state of the moving part or the end effector is any one of a position, a rotation, a translational speed, a rotational speed, a translational acceleration, a rotational acceleration, a translational jerk, and a rotational jerk.

7. The robot control system according to claim 5,
wherein the movement control part generates the movement control instruction based on a weight matrix for adjusting a scale of variation in the state of the moving part or the end effector within the allowable range.

8. The robot control system according to claim 1, further comprising:
an allowable range input part that inputs information associated with the allowable range;
an operation part that computes display information on the basis of the result of controlling the robot using the allowable range; and
a display part that displays the display information.

9. The robot control system according to claim 8,
wherein the display information includes any one of:
the allowable range; the state of the moving part or the arm; electric power consumed by the robot; and a completion time of the target motion of the arm.

10. The robot control system according to claim 8,
wherein the information associated with the allowable range includes any one of the state of the moving part or the end effector of the arm to which the allowable range is set, an upper limit of the allowable range, and a lower limit of the allowable range.

11. The robot control system according to claim 1, further comprising:
an arm motion command input part that inputs an arm motion command associated with a motion of the arm;
a moving part motion command input part that inputs an allowable range for a motion of the moving part;
a sensor that obtains information; and
a display part that displays the information obtained by the sensor,
wherein the arm control part generates an arm control instruction associated with the arm motion command and an arm state transition.

12. A robot control method for controlling a robot including an arm and a moving part, comprising:
a motion planning step of outputting a target motion associated with a motion of the arm and an allowable range for the motion of the moving part corresponding to the target motion;
an arm control step of outputting an arm control instruction associated with the target motion and an arm state transition;
a movement control step of generating a movement control instruction associated with the motion of the moving part to fall within the allowable range using the arm state transition; and
a robot control step of controlling the arm by the arm control instruction and controlling the moving part by the movement control instruction.

13. A robot control device that controls a robot including an arm and a moving part, comprising:
a motion planning part that outputs a target motion of a motion of the arm and an allowable range for the motion of the moving part corresponding to the target motion;
an arm control part that outputs an arm control instruction associated with the target motion and an arm state transition; and
a movement control part that generates a movement control instruction associated with a motion of the moving part to fall within the allowable range using the arm state transition.
